(19) United States
(12) Patent Application Publication
(10) Pub. No.: US 2021/0056436 A1
(43) Pub. Date: Feb. 25, 2021

(54) METHOD AND DEVICE FOR DYNAMICALLY DETERMINING AN ARTIFICIAL INTELLIGENCE MODEL

(71) Applicant: Lenovo (Singapore) Pte. Ltd., New Tech Park (SG)

(72) Inventors: Saba Arslan Shah, Morrisville, NC (US); Rod David Waltermann, Rougemont, NC (US); Sidney Phillip Rhodes, Chapel Hill, NC (US); Curtis Matthew Pasfield, Holly Springs, NC (US)

(21) Appl. No.: 16/544,082

(22) Filed: Aug. 19, 2019

(51) Int. Cl. G06N 5/02; G06N 20/00

(52) U.S. Cl. CPC G06N 5/02; G06N 20/00

(57) ABSTRACT

A computer implemented method, device, and computer program product for dynamically determining an artificial intelligence (AI) model for a device is provided. The method includes, under control of one or more processors configured with specific executable program instructions, receiving a request for an AI operation. The method analyzes utilization information indicative of a load experienced by one or more resources of the device. The method determines an AI model from a plurality of candidate AI models based, at least in part, on the utilization information and an quality potential for each candidate AI model of the plurality of candidate AI models.

### BACKGROUND

Embodiments herein generally relate to methods and systems for dynamically determining an artificial intelligence (AI) model for implementation on a client device.

Conventionally, client devices transmit requests for AI operations over a network to a resource manager (e.g., a server) and AI models are executed on the resource manager to conserve resources at the client device. The resource manager transmits predictions generated by the AI models back to the client device, where the client device can base further actions on the predictions. In cases where real-time predictions are required, the absence of a network connection or delay in receiving predictions can undermine the value of the predictions and further actions at the client device based on the predictions.

Attempts to address these shortcomings by implementing the same AI models on both the client devices and resource managers have been limited by the capability of the client devices. However, the ever-increasing heterogeneity of computing environments provides a further challenge to implementing AI operations across the broad range of devices seeking to employ AI operations. Devices seeking to employ AI operations vary greatly in computing capability. Such devices include personal computers, tablet devices, laptop computers, embedded appliances (e.g., thermostats, home monitoring systems, and the like), smart watches, medical devices, vehicles, digital assistants, and an entire array of other smart consumer goods. As such, some devices are capable of running more complex AI models that render more accurate predictions, while some devices are limited to running less complex AI models that render predictions that are less accurate.

Accordingly, a need remains for methods, devices, and computer program products that dynamically determine an AI model for implementation on a client device that do not adversely impact or reduce functionality of the client device for an end user and/or depend on network availability.

### SUMMARY

In accordance with embodiments herein, a computer implemented method for dynamically determining an artificial intelligence (AI) model for a device is provided. The method includes, under control of one or more processors configured with specific executable program instructions, receiving a request for an AI operation. The method analyzes utilization information indicative of a load experienced by one or more resources of the device. The method determines an AI model from a plurality of candidate AI models based, at least in part, on the utilization information and an quality potential for each candidate AI model of the plurality of candidate AI models.

Optionally, the plurality of candidate AI models may include first and second candidate AI models having first and second quality potentials, respectively, the first quality potential being lower than the second quality potential. The method may select the first candidate AI model with the lower first quality potential instead of the second candidate AI model in connection with the load experienced by the one or more resources of the device exceeding a device load threshold.

Optionally, the plurality of candidate AI models may include first and second candidate AI models having first and second quality potentials, respectively, the first quality potential being higher than the second quality potential. The method may select the first candidate AI model with the higher first quality potential instead of the second candidate AI model in connection with the load experienced by the one or more resources of the device falling below a device load threshold.

Optionally, the quality potential for a candidate AI model may be based, at least in part, on the degree of computational complexity of the candidate AI model. The method may include determining the AI model based on a solution-based constraint for the AI operation. The method, as part of the determining, may select the AI model from a database of the plurality of candidate AI models and the quality potentials for each candidate AI model of the plurality of candidate AI models. The utilization information may be indicative of the load experienced by the one or more resources of the device due to one or more of a level of processor usage, a level of memory usage, a level of a network load, and a level of battery charge. The method may execute the AI model on the device and generating a prediction based on the executing. The method may store the prediction and/or act on the prediction.

In accordance with embodiments herein, a device for dynamically determining an artificial intelligence (AI) model is provided. The device includes one or more processors and memory storing program instructions accessible by the one or more processors. The one or more processors, responsive to execution of the program instructions, receive a request for an AI operation. The one or more processors analyze utilization information indicative of a load experienced by one or more resources of the device. The one or more processors determine an AI model from a plurality of candidate AI models based, at least in part, on the utilization information and an quality potential for each candidate AI model of the plurality of candidate AI models.

Optionally, the plurality of candidate AI models may include first and second candidate AI models having first and second quality potentials, respectively, the first quality potential being lower than the second quality potential. The one or more processors, as part of the determine, may select the first candidate AI model with the lower first quality potential instead of the second candidate AI model in connection with the load experienced by the one or more resources of the device exceeding a device load threshold.

Optionally, the plurality of candidate AI models may include first and second candidate AI models having first and second quality potentials, respectively, the first quality potential being higher than the second quality potential. The one or more processors, as part of the determine, may select the first candidate AI model with the higher first quality potential instead of the second candidate AI model in connection with the load experienced by the one or more resources of the device falling below a device load threshold.

Optionally, the quality potential for a candidate AI model may be based, at least in part, on the degree of computational complexity of the candidate AI model. The one or more processors, as part of the determine, may determine the AI model based on a solution-based constraint for the AI operation. The one or more processors, as part of the determine, may select the AI model from a database of the plurality of candidate AI models and the quality potentials for each candidate AI model of the plurality of candidate AI models. The utilization information may be indicative of the load experienced by the one or more resources of the device due to one or more of a level of processor usage, a level of memory usage, a level of a network load, and a level of battery charge.

In accordance with embodiments herein, a computer program product comprising a non-transitory computer readable storage medium storing computer executable code is provided. The computer executable code receives a request for an AI operation. The computer executable code analyzes utilization information indicative of a load experienced by one or more resources of the device. The computer executable code determines an AI model from a plurality of candidate AI models based, at least in part, on the utilization information and a quality potential for each candidate AI model of the plurality of candidate AI models.

Optionally, the plurality of candidate AI models may include first and second candidate AI models having first and second quality potentials, respectively, the first quality potential being lower than the second quality potential. The computer executable code, as part of the determine, may select the first candidate AI model with the lower first quality potential instead of the second candidate AI model in connection with the load experienced by the one or more resources of the device exceeding a device load threshold.

Optionally, the plurality of candidate AI models may include first and second candidate AI models having first and second quality potentials, respectively, the first quality potential being higher than the second quality potential. The computer executable code, as part of the determine, may select the first candidate AI model with the higher first quality potential instead of the second candidate AI model in connection with the load experienced by the one or more resources of the device falling below a device load threshold. The quality potential for a candidate AI model may be based, at least in part, on the degree of computational complexity of the candidate AI model.

### DESCRIPTION OF THE DRAWINGS

FIG. 1 illustrates a system to dynamically determine an AI model implemented in accordance with embodiments herein.

FIG. 2 illustrates a functional diagram of portions of the system of FIG. 1 as well as a first example of certain data, information, and content conveyed in accordance with embodiments herein.

FIG. 3 illustrates a functional diagram of portions of the system of FIG. 1 as well as a second example of certain data, information, and content conveyed in accordance with embodiments herein.

FIG. 4 illustrates an exemplary processes for dynamically determining an AI model in accordance with embodiments herein.

FIG. 5 illustrates one example of a collection of communications between the client device and the resource manager in accordance with embodiments herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

An “artificial intelligence model”, or “AI model”, as used herein includes, but is not limited to, neural networks such as recurrent neural networks, recursive neural networks, feed-forward neural networks, convolutional neural networks, deep belief networks, and convolutional deep belief networks; multi-layer perceptrons; decision trees; self-organizing maps; deep Boltzmann machines; logistic regression algorithms; regression algorithms; stacked de-noising auto-encoders; and the like. Additionally or alternatively, AI models include machine learning algorithms and other types or rules-based predictive algorithms and techniques. Additionally or alternatively, an AI model may refer to a trained AI model. Additionally or alternatively, each AI model can include a collection of AI objects corresponding to a complex task that is attempted to be analyzed and solved by the AI model. The AI objects may be maintained in an AI object database so that reuse, recomposition, and/or reconfiguration of all or part of an AI model is possible.

The term “utilization information” refers to information characterizing the system capabilities and/or a load experienced by a client device and/or one or more resources of the client device. Non-limiting examples of utilization information include a type of CPU, an amount/level of a CPU characteristic (e.g., frequency), an amount/level of memory, an amount/level of memory utilization, an amount/level of CPU activity, an amount/level of hard drive utilization, an amount/level of operations performed by the CPU (e.g., performing an anti-virus scan), a nature of operations performed by the CPU, an amount/level of battery capacity, an amount/level of charge on a battery, and the like. Additionally or alternatively, the utilization information may include an amount/level of hardware capabilities of the device, such as whether the device includes any additional specialized code processing hardware (e.g., a DSP chip, a TPU, or the like). Additionally or alternatively, the utilization information may include network load experienced by the client device. The utilization information of the client device may be calculated based on trend data based on prior utilization of the client device. The utilization information may include an ensemble of utilization information values that are mathematically combined, such as through averaging, obtaining a mean, median, etc., to form a composite current utilization information value (e.g., a moving average).

The terms “solution-based constraints” and “SBC” refer to one or more constraints imposed on the prediction and/or solution generated by an AI model to meet a threshold level of one or more of estimated model accuracy, estimated model timeliness, and the like. The SBC may be calculated based on trend data based on prior utilization of an AI model on the client device. The SBC may include an ensemble of SBC values that are mathematically combined, such as through averaging, obtaining a mean, median, etc., to form a composite current SBC value (e.g., a moving average). For example, the SBC may be a threshold level of estimated model accuracy required for the AI model to render a useful prediction.

The term “quality potential” refers to an estimated level of prediction quality of an AI model. The prediction quality is the degree to which the prediction generated by the AI model renders a correct value or conforms to a standard. The prediction quality may be determined based on one or more of estimated level of model accuracy, precision, recall, F 1 scores, Area Under the Curve (AUC), an impact of the number of variables on the AI model, the impact of the number of features utilized for the AI model, and the like. In one example, the quality potential for a given AI model may be the percentage of instances, over a time period, that the prediction generated by the AI model corresponded to a correct value or an outcome. In an additional or alternative example, the quality potential for a given AI model may be the degree or extent to which the prediction generated by the AI model corresponded to a correct value or an outcome. The quality potential for an AI model may be calculated based on trend data based on prior utilization of the AI model on one or more client devices. The quality potential may include an ensemble of quality potential values that are mathematically combined, such as through averaging, obtaining a mean, median, etc., to form a composite current quality potential value (e.g., a moving average).

The term “computational complexity” refers to an estimated number of operations an AI model needs to perform to generate a prediction. The computational complexity of an AI model may be expressed using, for example and without limitation, Big 0 notation and the like. AI models that have high quality potentials may be overfitting and/or require higher numbers of operations to generate a prediction than do AI models having low quality potentials. As such, AI models with high quality potentials exhibit higher computational complexity than AI models with low quality potentials. The more computationally complex an AI model is, the more levels or amounts of resources are required for the AI model to generate a prediction. Resources include processor usage, memory usage, disk usage, network usage, and the like. The computational complexity for an AI model may be calculated based on trend data based on prior utilization of the AI model on one or more client devices. The computational complexity may include an ensemble of computational complexity values that are mathematically combined, such as through averaging, obtaining a mean, median, etc., to form a composite current computational complexity value (e.g., a moving average).

The term “obtain” or “obtaining”, as used in connection with data, signals, information and the like, includes at least one of i) accessing memory of a local external device or resource manager where the data, signals, information, etc. are stored, ii) receiving the data, signals, information, etc. over a wireless communications link between the client device and a local external device, and/or iii) receiving the data, signals, information, etc. at a resource manager over a network connection. The obtaining operation, when from the perspective of a client device, may include sensing new signals in real time, and/or accessing memory to read stored data, signals, information, etc. from memory within the client device. The obtaining operation, when from the perspective of a local external device, includes receiving the data, signals, information, etc. at a transceiver of the local external device where the data, signals, information, etc. are transmitted from a client device and/or a resource manager. The obtaining operation may be from the perspective of a resource manager, such as when receiving the data, signals, information, etc. at a network interface from a local external device and/or directly from a client device. The resource manager may also obtain the data, signals, information, etc. from local memory and/or from other memory, such as within a cloud storage environment and/or from the memory of a workstation.

### System Overview

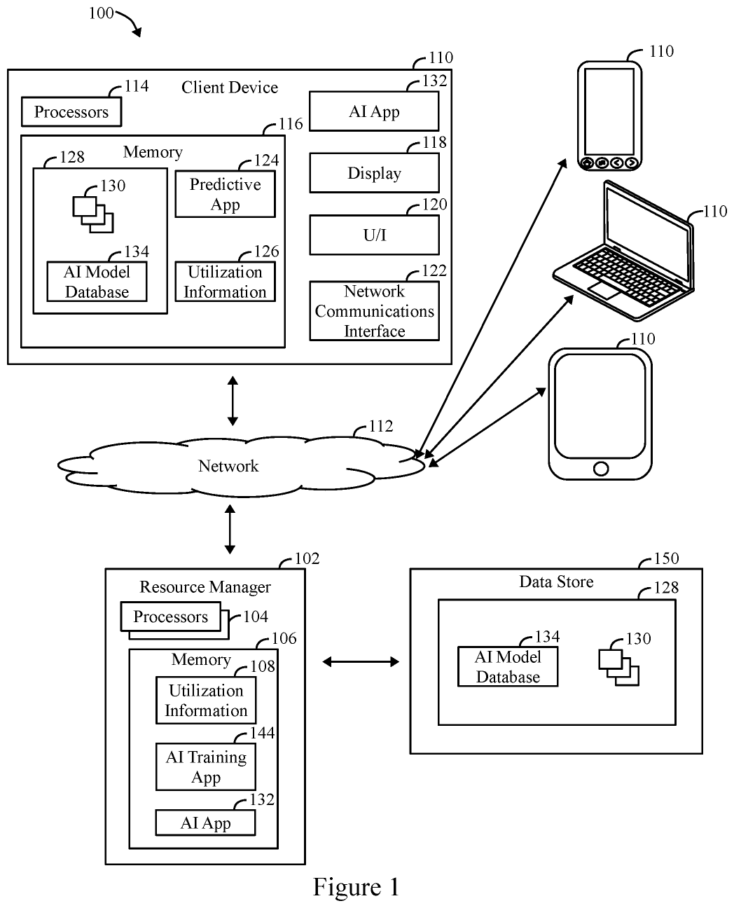

FIG. 1 illustrates a system 100 implemented in accordance with embodiments herein for dynamically determining an AI model. The system includes one or more client devices 110 that manage and otherwise provide access to one or more client-side AI model libraries 128. The system 100 also includes one or more resource managers 102 that manage and otherwise provide access to one or more data stores 150 containing one or more server-side AI model libraries 128. The resource manager 102 communicates with client devices 110 through one or more networks 112 to provide access to the data store 150. The network 112 may represent the World Wide Web, a local area network, a wide area network and the like. The client device 110 may represent various types of electronic devices including, but not limited to, personal computers, tablet devices, laptop computers, embedded appliances (e.g., thermostats, home monitoring systems, and the like), smart watches, medical devices, vehicles, digital assistants, and an entire array of other smart consumer goods. The resource manager 102 may represent a server or other network-based or cloud-based computing environment. The resource manager 102 may represent a single computer system or a collection of computer systems located at a common location or geographically distributed.

The client device 110 includes one or more processors 114, memory 116, a display 118, a user interface 120, a network communications interface 122, and various other mechanical components, electrical circuits, hardware and software to support operation of the client device 110. The memory 116 includes an operating system and instructions to implement the processes described herein. The memory 116 also stores one or more application programs to implement a predictive application 124 and an AI application 132, as well as other software, information and data as described herein. For example, the memory 116 may maintain utilization information 126 related to the load experienced by the client device 110 and an AI model library 128. The AI model library 128 includes a plurality of candidate AI models 130 and an AI model database 134. The candidate AI models 130 may be organized and maintained within an AI model database 134, which may be implemented in any manner of data sources, such as data bases, text files, data structures, libraries, relational files, flat files and the like. The AI model database includes a list of the plurality of candidate AI models 130 and the quality potentials for each of the candidate AI models 130. The one or more processors 114 may update the utilization information 126 periodically based on load changes. Additionally or alternatively, the one or more processors 114 may update the AI model library 128 periodically based on changes in conditions affecting one or more candidate AI models 130 in the AI model library 128 and/or to update the number and types of candidate AI models 130 included in the AI model library 128. Additionally or alternatively, the one or more processors 114 may receive updates to the AI model library 128 pushed to the client device 110 by the resource manager 102.

The predictive application 124 generates and sends a request to an AI application 132 in connection with an AI operation. The predictive application 124 receives a prediction (or solution) from the AI application 132 in connection with the request. For example, the predictive application 124 may be a predictive maintenance application and the request may represent a request for an AI operation to predict an amount or a level associated with a component of the client device 110. A predictive maintenance application may manage usage of component of a client device 110 such as, for example and without limitation, a battery, a vacuum bag, a printer ink cartridge, a filter, a paper source, and the like. The predictive application 124 utilizes the AI prediction to generate, among other things, an action or an alert based on the prediction.

The AI application 132 receives a request for an AI operation from the predictive application 124. Based on the request, the AI application 132 analyzes utilization information 126 indicative of a load experienced by one or more resources of the client device 110. For example, the utilization information 126 may indicate the load experienced by one or more resources of the client device 110 as one or more of a level of processor usage, a level of memory usage, a level of network load, a level of battery charge, and the like. The AI application 132 determines an AI model from the plurality of candidate AI models 130 based, at least in part, on the utilization information 126 and a quality potential for each candidate AI model 130 of the plurality of candidate AI models. The quality potential for a given candidate AI model 130 is based, at least in part, on the degree of computational complexity of the candidate AI model 130. The AI application 132 may further determine the AI model based on an SBC for the AI operation, such as a threshold level of quality, accuracy and/or timeliness required for the prediction to be useful. Based on the determination of the AI model, the AI application 132 executes the AI model and generates a prediction. The AI application 132 transmits the prediction to the predictive application 124.

For example, for a given load experienced by a client device 110, the AI application 132 determines an AI model based on the load exceeding or falling below a threshold. The plurality of candidate AI models 130 includes a first candidate AI model (e.g., a neural network model, a logistic regression model, a multilayer perceptron model, and the like) having a first quality potential and second candidate AI model (e.g., a deep learning model, a deep belief network model, and the like) having a second quality potential that is higher than the first quality potential. The second candidate AI model, having the higher quality potential, is more computationally complex than the first candidate AI model and places a higher added load on the one or more resources of the client device 110 upon execution than the first candidate AI model. The AI application 132 utilizes the AI model database 134 to select the AI model having the highest quality potential whose execution will not exceed the capability of, or impede higher priority functions of, the client device 110. The AI Application 132 selects the first candidate AI model with the higher first quality potential instead of the second candidate AI model in connection with the load experienced by the one or more resources of the device falling below a device load threshold. For example, if the amount/level of processor usage on the client device falls below a select threshold value (e.g., 60%), the AI application 132 selects the second candidate AI model in order to generate a more accurate prediction. The additional processor usage placed on the one or more resources of the client device 110 by executing the second candidate AI model is within the capability of the client device 110 and does not take away processor usage from higher priority functions performed by the client device 110. Conversely, the AI application 132 selects the first candidate AI model with the lower first quality potential instead of the second candidate AI model in connection with the load experienced by the one or more resources of the device exceeding a device load threshold. For example, if the amount/level of processor usage on the client device exceeds the select threshold value (e.g., 60%), the AI application 132 selects the first candidate AI model in order to generate a less accurate prediction but that requires a level of processor usage consistent with the capability and functioning of the client device 110.

In one embodiment, the one or more processors 114 of the client device 110 monitor internal workload of the processors 114, memory usage, network load, battery usage, and other internal resources. The utilization information 126 may be indicative of the present load experienced at the client device 110. Additionally or alternatively, the utilization information 126 may represent a prediction or expectation of future load that will occur at some point in the future while the predictive application 124 requests an AI operation. For example, the one or more processors 114 may track, as utilization information 126, usage patterns experienced by the one or more resources of the client device 110. The AI application 132, as part of analyzing the utilization information 126, determines that at certain times of day, certain days of the week and the like, usage of the one or more resources increases to relatively heavy levels. When the AI application 132 expects heavy usage during one of these high usage time periods, the AI application 132 may select an AI model having a lower quality potential, even though the instantaneous load at the one or more resources of the client device 110 is relatively low.

The resource manager 102 includes one or more processors 104 and memory 106, among other structures that support operation of the resource manager 102. The memory 106 includes an operating system, instructions to manage the data store 150 and instructions to implement the methods described herein. The memory 106 also stores utilization information 108 related to loads experienced by the one or more resources of one or more client devices 110. The resource manager 102 may be a device associated with a cloud-based computing environment, an edge device associated with a network, and the like. In accordance with embodiments herein, the resource manager 102 trains the candidate AI models 130 and pushes updates to the client-side AI model libraries 128. For example, an AI training application 144 on the resource manager 102 may use machine learning to selectively train or re-train one or more of the plurality of candidate AI models 130. The AI training application 144 may apply data transmitted to the resource manager 102 by one or more client devices 110 in order to improve the speed, accuracy, precision, processing time, or the like for one or more of the candidate AI models 130. For example, the AI training application 144 may determine whether a previous change to one or more of the candidate AI models 130 was effective in driving the AI application 132 and/or the predictive application 124 to a desired change. In an additional or alternative example, the AI training application 144 may also update one or more candidate AI models 130 by replacing or changing the one or more candidate AI models 130, such as by replacing or changing particular algorithms run by one or more of the candidate AI models 130. The updates may be done individually for each candidate AI model 130 of the plurality of AI models. The resource manager 102 stores the current versions of each of the plurality of candidate AI models 130 in the server-side AI model library 128 on the data store 150, as well as updates the AI model database 134 stored therein. The data store 150 may store the plurality of candidate AI models 130 organized in various manners and related to a wide variety of types of AI operations. The candidate AI models 130 may be organized and maintained within an AI model database 134, which may be implemented in any manner of data sources, such as data bases, text files, data structures, libraries, relational files, flat files and the like. The resource manager 102 pushes updates to the one or more client devices 110 periodically to update the client-side AI model libraries 128 implemented thereon. It is recognized that the resource manager 102 performs other operations, not described herein, such as operations associated with maintaining resources and the like.

In additional or alternative embodiments, the AI application 132 is implemented on the resource manager 102. For example, the resource manager 102 may receive a request for an AI operation from a client device 110, along with or contemporaneously with utilization information 126 for the device. For example, the client device 110 sends a HTTP request, which includes a request for an AI operation generated by the predictive application 124. The request may also include data concerning the client device 110 (IP address, type of browser, browser version, mobile/desktop device). At the same time or contemporaneously therewith, the client device 110 may also send utilization information concerning the capabilities of the client device and the current load experienced by the client device 110 and/or a prediction of a load to be experienced in a near future (e.g., based on calendar events or the like). Based on the request, the AI application 132 analyzes the capabilities of the client device 110 to determine an AI model from the plurality of candidate AI models 130 stored in the server-side AI model library 128 of the data store 150. Additionally or alternatively, the AI application 132 may analyze utilization information 126 indicative of a load experienced by one or more resources of the client device 110 and, respectively, confirm or determine an AI model from a plurality of candidate AI models 130 stored in the server-side AI model library 128 of the data store 150. Additionally or alternatively, the AI application 132 obtain information regarding one or more similar systems to determine the AI model from the plurality of candidate AI models stored on the server-side AI model library 128. The resource manager 102 pushes the AI model to the client device 110 for execution thereon.

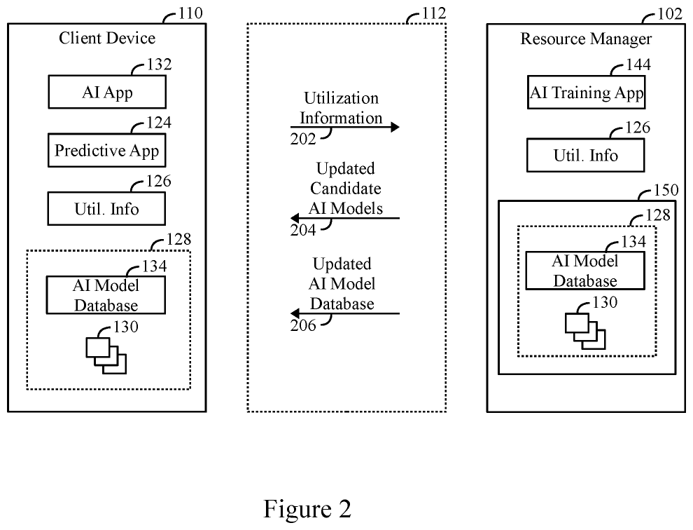

FIG. 2 illustrates a functional diagram of portions of the system of FIG. 1 as well as a first example of certain data, information, and content conveyed in accordance with embodiments herein. In FIG. 2, the system 100 is implemented as described herein to run the AI application 132 on the client device 110. The client device 110 and the resource manager 102 communicate on a periodic basis only. For example, at 202, the client device 110 transmits utilization information to the resource manager 102 over the network 112. The resource manager 102 may store utilization information 108 related to loads experienced by the one or more resources of one or more client devices 110. The resource manager 102, at the AI training application 144, may apply data transmitted to the resource manager 102 by one or more client devices 110 in order to improve the speed, accuracy, precision, processing time, or the like for one or more of the candidate AI models 130. In an additional or alternative example, at 204 and 206, the resource manager 102 pushes periodic updates to the client device 110 in order to update one or more of the plurality of candidate AI models 130 and the AI model database 134.

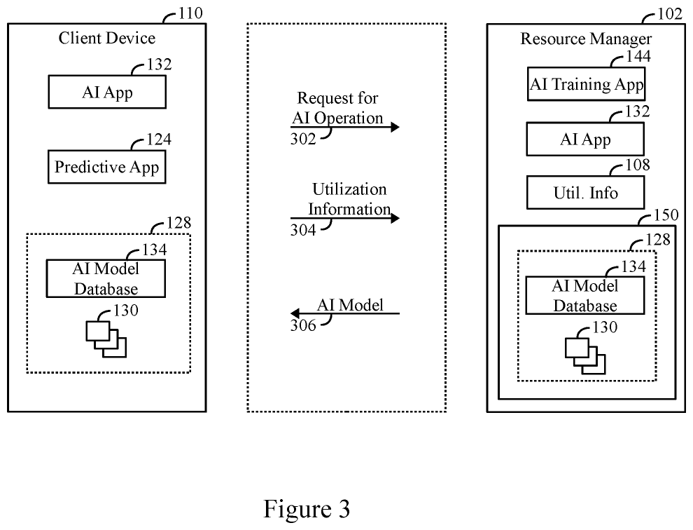

FIG. 3 illustrates a functional diagram of portions of the system of FIG. 1 as well as a first example of certain data, information, and content conveyed in accordance with embodiments herein. In FIG. 3, the system 100 is implemented as described herein to run the AI application 132 on the client device 110. The client device 110 and the resource manager 102 communicate each time the client device 110 generates a request for an AI operation. For example, the client device 110, via the predictive application 124, generates and transmits a request for an AI resource (e.g., an AI resource to estimate the level of ink remaining in a printer cartridge) to the resource manager 102 over the network 112. For example, at 302, the client device 110 sends a HTTP request, which includes the request for an AI operation. The request may also include data concerning the client device 110 (e.g., IP address, type of operating system, operating system version, identification of the ink cartridge, and the like). At 304, the client device 110 transmits utilization information 108 concerning the current load experienced by the one or more resources of the client device 110 to the resource manager 102. The utilization information 126 may indicate one or more of system capabilities, a level of processor usage, a level of memory usage, a level of network load, a level of battery usage, a level of usage of electronic devices peripheral to the engine, and the like present at the client device 110 and/or a prediction or expectation of a future load that will occur based on usage patterns monitored at the client device. Transmission of the request for an AI model and transmission of the utilization information 108 may occur contemporaneously or at different frequencies and times. Based on the request transmitted by the client device 110, the resource manager 102 analyzes the utilization information 126 indicative of the system capabilities of the client device 110 and utilizes the AI model database 134 to determine the AI model having the highest quality potential whose execution will not exceed the system capabilities of the client device 110. Additionally or alternatively, the resource manager 102 may analyze utilization information 126 indicative of a current and/or future load experienced by the client device 110 to, respectively, confirm or determine the AI model having the highest quality potential whose execution will not exceed the current and/or future load of the client device 110. The resource manager 102 may analyze the utilization information by comparing the utilization information 108 to a one or more thresholds. As one example, the resource manager 102 may determine that a level of network load at the client device 110 is above or below a threshold (e.g., 70%). Based on analysis of the utilization information 108, the resource manager 102 utilizes the AI model database 134 to select the AI model having the highest quality potential whose execution will not exceed the capability of, or impede higher priority functions of, the client device 110. At 306, the resource manager 102 pushes the AI model to the client device 110. The client device 110 executes the AI model to generate the prediction. The client device 110 stores and/or utilizes the prediction, at the predictive application 124, to generate a notice or alert (e.g., an alert indicating the remaining level of ink and estimated time until depletion of the ink).

### Process for Dynamically Determining an AI Model

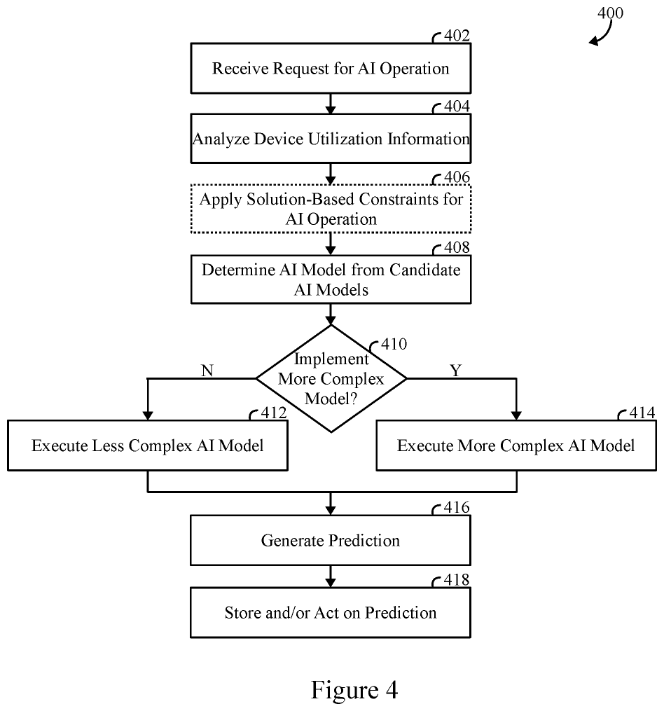

FIG. 4 illustrates a process 400 for dynamically determining an AI model for implementation on a client device 110 in accordance with embodiments herein. The operations of FIG. 4 may be implemented by processors (e.g., the processors 104 and 114), hardware and circuits within the systems described in the various embodiments herein. The operations of FIG. 2 may be performed continuously or periodically. For simplicity purposes, the operations of FIG. 4, will be described in connection with one request, however it is recognized that a client device 110 may provide multiple requests in connection with dynamically determining an AI model for implementation thereon. Optionally, the operations of FIG. 4 may be performed upon select requests from a client device 110, upon every request from a client device 110, upon groups of requests from a client device 110 or otherwise. Optionally, the operations of FIG. 4 may be performed in parallel for multiple client devices 110 on one or more resource managers 102.

At 402, one or more processors receive a request for an AI operation. The request may be provided in connection with various types of operations and from various types of applications implemented on the client device 110. For example, a client device 110 (e.g., a smart phone, personal computer and the like) may operate a predictive application 124. The predictive application 124 generates and sends a request for an AI operation to the AI Application 132. For example, the predictive application 124 may be a predictive maintenance application and the request may represent a request for an AI operation to predict an amount or a level associated with a component of the client device 110, such as, for example and without limitation, a battery, a vacuum bag, a printer ink cartridge, a filter, a paper source, and the like. Optionally, based on the client device 110 transmitting the request for the AI operation to the resource manager 102, the client device 110 may also transmit utilization information along with or contemporaneously with the request for the AI operation.

At 404, the one or more processors analyze utilization information 126 related to the one or more resources of the client device 110. For example, utilization information 126 may indicate the capabilities of the client device and/or the load of the one or more resources of the client device 110 as one or more of a level of processor usage, a level of memory usage, a level of network load, a level of battery charge, and the like.

Optionally, at 406, the one or more processors apply an SBC associated with the AI operation. An SBC for the AI operation may represent, for example and without limitation, a threshold level of quality, accuracy and/or a threshold level of timeliness required for the prediction to be useful.

At 408, the one or more processors determine an AI model from the plurality of candidate AI models 130. The determination at 406 is based, at least in part, on the utilization information 126 for the client device 110, such as a comparison between the utilization information 126 and one or more thresholds, and the quality potentials of the plurality of candidate AI models 130. As one example, the one or more processors may determine that processor usage at the client device 110 is above a threshold (e.g., 60% usage). Various examples of utilization information 126 are provided herein, each of which may have a corresponding threshold. Additionally or alternatively, the one or more processors may analyze multiple types of utilization information 126 relative to corresponding thresholds and apply a weighted combination that is used to determine an AI model from the plurality of candidate AI models 130. For example, the same or different weights may be applied to relations between processor usage and a processor usage threshold, memory usage and a memory usage threshold, and the like. The quality potentials for the candidate AI models 130 are based, at least in part, on the degree of computational complexity of the candidate AI models 130.

At 410, the one or more processors determine whether to implement a more complex model from the plurality of candidate AI models 130. Based on the utilization information 126 exceeding or falling below a corresponding threshold, the one or more processors determine whether to implement an AI model having a higher or lower quality potential from the plurality of candidate AI models 130. The one or more processors use the AI model database 134 to select the AI model from the plurality of candidate AI models 130. The AI model database 134 may be implemented in any manner of data sources, such as data bases, text files, data structures, libraries, relational files, flat files and the like. The AI model database includes a list of the plurality of candidate AI models 130 and the quality potentials for each of the candidate AI models 130. The AI application 132 utilizes the AI model database 134 to select the AI model having the highest quality potential whose execution will not exceed the capability of, or impede higher priority functions of, the client device 110. The AI application 132 may also select the AI model with a threshold for a level of accuracy versus increase in computational load when analyzing the plurality of candidate AI models 130. Optionally, based the client device 110 transmitting the request for the AI operation to the resource manager 102, the resource manager pushes the AI model to the client device 110 for execution by the one or more processors of the client device 110. When the one or more processors determines not to implement a more computationally complex AI model having a higher quality potential or determines to implement a less computationally complex AI model having a lower quality potential, flow branches to 412. At 412, the one or more processors execute the less computationally complex AI model. When the one or more processors determines to implement a more computationally complex AI model having a higher quality potential, flow branches to 414. At 414, the one or more processors execute the more computationally complex AI model.

For example, based on the utilization information 126 (e.g., a level of network load usage) falling below or exceeding a corresponding threshold (e.g., 60%), the one or more processors determine to implement an AI model from the plurality of candidate AI models 130 having, respectively, a higher or lower quality potential. The plurality of candidate AI models 130 includes a first candidate AI model (e.g., a logistic regression model, a multilayer perceptron model, and the like) having a first quality potential and second candidate AI model (e.g., a neural network model, a deep learning model, a deep belief network model, and the like) having a second quality potential that is higher than the first quality potential. For example, when the network load falls below the corresponding threshold (e.g., 60%), the one or more processors implement the second candidate AI model having the higher quality potential, and thus computational complexity, as compared to the first candidate AI model. The additional network load placed on the client device 110 by executing the second candidate AI model (e.g., to render a prediction on battery life) is within the capability of the client device 110 and does not take away network usage due to higher priority activities (e.g., a user engaging in a gaming activity). Conversely, when the network load exceeds the corresponding threshold, the one or more processors implement the first candidate AI model having the lower quality potential, and thus computational complexity, in order to generate a less accurate but still useful prediction that does not detract from the level of network usage of the higher priority activity.

At 416, the one or more processors generate the prediction from the AI model. At 218, the one or more processors act on and/or store the prediction. The predictive application 124 receives the prediction based on the request for an AI model and generates an alert or notice based thereon. For example, the predictive application 124 may be a predictive maintenance application and the prediction may represent an amount or a level associated with a component of the client device 110, such as, for example and without limitation, a battery, a vacuum bag, a printer ink cartridge, a filter, a paper source, and the like. The predictive application 124, based on the prediction, generates an alert or notice 418 related to a need to replenish or maintain the component within a select time (e.g., indicate a need to take a charger for a battery to a next calendared meeting, indicate a need to order a replacement vacuum bag, printer ink cartridge, filter or paper based on estimated depletion of the amount or level thereof, and the like).

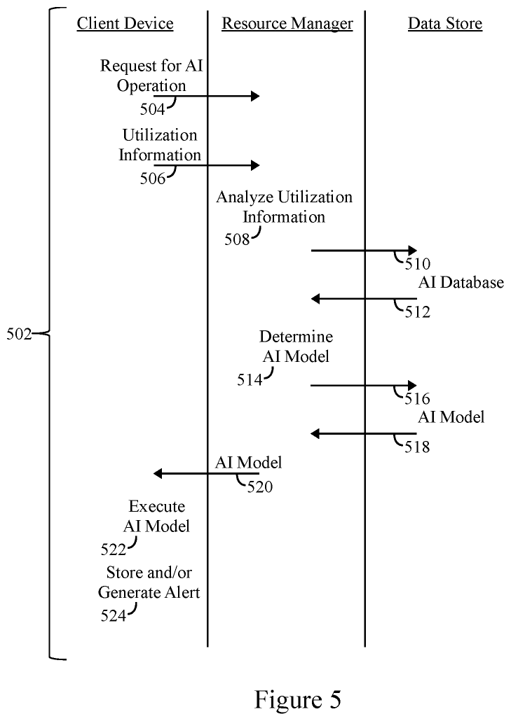

FIG. 5 illustrates one example of a collection of communications between the client device 110, the resource manager 102, and the data store 150 wherein the AI model is selected on the resource manager 102 and pushed to the client device 110 for execution in accordance with embodiments herein. For convenience, reference is made to the devices of FIG. 1 in connection with FIG. 5. For example, the client device 110 may represent various types of electronic devices including, but not limited to, personal computers, tablet devices, laptop computers, embedded appliances (e.g., thermostats, home monitoring systems, and the like), smart watches, medical devices, vehicles, digital assistants, and an entire array of other smart consumer goods. The resource manager 102 represents a server or other network-based or cloud-based computing environment. The data store 150 represents a server or other network-based or cloud-based computing environment that stores the plurality of candidate AI models 130 and the AI model database 134.

During an AI application session 502, at 504, a client device 110 utilizes the predictive application 124 to generate and send a request for an AI resource (e.g., an AI resource to estimate the remaining battery life in an electric vehicle) to the resource manager 102. For example, the client device 110 sends a HTTP request, which includes the request for an AI operation generated by the predictive application 124. The request may also include data concerning the client device 110 (e.g., IP address, type of operating system, operating system version, identification of the driver, and the like). At 506, the client device 110 transmits utilization information 126 for the client device 110 to the resource manager 102. For example, the utilization information 126 may indicate a level of processor usage, memory usage, network load, battery usage, a level of usage of electronic devices peripheral to the engine, and the like present at the client device 110 and/or a prediction or expectation of a future load that will occur based on usage patterns monitored at the client device.

At 508, based on the request, the resource manager 102 analyzes the utilization information 126 indicative of a current or future load experienced by the client device 110. The resource manager 102 may analyze the utilization information by comparing the utilization information 126 to a one or more thresholds. As one example, the resource manager 102 may determine that a level of battery charge at the client device 110 is above or below a threshold (e.g., 50% usage). Various examples of utilization information 126 are provided herein, each of which may have a corresponding threshold.

At 510, the resource manager 102 conveys a request to the data store for the AI model database 134 for the plurality of candidate AI models 130. At 512, in response to the request, the data store 150 returns the AI model database 134 to the resource manager 102. At 514, the resource manager 102 determines whether to implement an AI model having a higher or lower quality potential from the plurality of candidate AI models 130 based on the utilization information 126 exceeding or falling below a corresponding threshold (e.g., 50% usage for a level of battery charge). The resource manager 102 utilizes the AI model database 134 to select the AI model having the highest quality potential whose execution will not exceed the capability of, or impede higher priority functions of, the client device 110. For example, a higher priority function of the client device 110 may include an application in use to autonomously navigate the electric vehicle. The plurality of candidate AI models 130 includes a first candidate AI model (e.g., a deep neural network having 10 layers) having a first quality potential, and a second candidate AI model (e.g., a deep neural network having 50 layers) having a second quality potential. The first quality potential is lower than the second quality potential. In one example, based on a level of battery charge falling below the 50% usage threshold, the resource manager 102 determines that the first candidate AI model (e.g., a deep neural network having 10 layers) having the lower quality potential should be implemented on the client device 110. The additional network load placed on the client device 110 by executing the first candidate AI model (e.g., to render a prediction on battery life) is within the capability of the client device 110, does not take away network usage due to higher priority activities (e.g., autonomously navigation), and yields a less accurate but still useful prediction. Conversely, based on a level of battery charge exceeding the 50% usage threshold, the resource manager 102 determines that the second candidate AI model (e.g., a deep neural network having 50 layers) having the higher quality potential should be implemented on the client device 110. The additional network load placed on the client device 110 by executing the second candidate AI model (e.g., to render a prediction on battery life) is within the capability of the client device 110, does not take away network usage due to higher priority activities (e.g., autonomously navigation), and yields the most useful prediction.

At 516, the resource manager 102 conveys a request to the data store for the AI model. At 518, in response to the request, the data store 150 returns the AI model to the resource manager 102. At 520, the resource manager 102 pushes the AI model to the client device 110.

At 522, the client device 110 executes the AI model to generate the prediction. At 524, the client device 110, at the predictive application 124, stores the prediction and/or utilizes the prediction to generate a notice or an alert (e.g., an alert indicating remaining number of miles or a remaining amount of time before the battery is depleted) to a user of the client device 110.

### Closing Statements

In accordance with at least one embodiment herein, to the extent that mobile devices are discussed herein, it should be understood that they can represent a very wide range of devices, applicable to a very wide range of settings. Thus, by way of illustrative and non-restrictive examples, such devices and/or settings can include mobile telephones, tablet computers, and other portable computers such as portable laptop computers.

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

Aspects are described herein with reference to the figures, which illustrate example methods, devices and program products according to various example embodiments. These program instructions may be provided to a processor of a general-purpose computer, special purpose computer, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the function/act specified. The program instructions may also be loaded onto a device to cause a series of operational steps to be performed on the device to produce a device implemented process such that the instructions which execute on the device provide processes for implementing the functions/acts specified.

Although illustrative example embodiments have been described herein with reference to the accompanying figures, it is to be understood that this description is not limiting and that various other changes and modifications may be affected therein by one skilled in the art without departing from the scope or spirit of the disclosure.

The modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming.

The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, in the following claims, the phrases “at least A or B”, “A and/or B”, and “one or more of A and B” (where “A” and “B” represent claim elements), are used to encompass i) A, ii) B and/or iii) both A and B. For the avoidance of doubt, the claim limitation “associated with one or more of the client device and a user of the client device” means and shall encompass i) “associated with the client device”, ii) “associated with a user of the client device” and/or iii) “associated with both the client device and a user of the client device”. For the avoidance of doubt, the claim limitation “one or more of touch, proximity sensing, gesture or computer vision” means and shall encompass i) “touch”, ii) “proximity”, (iii) “sensing”, (iv) “gesture”, and/or (iv) “computer vision” and any sub-combination thereof.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A computer implemented method for dynamically determining an artificial intelligence (AI) model for a device, the method comprising:
under control of one or more processors configured with specific executable program instructions:
receiving a request for an AI operation;
analyzing utilization information indicative of a load experienced by one or more resources of the device; and
determining an AI model from a plurality of candidate AI models based, at least in part, on the utilization information and a quality potential for each candidate AI model of the plurality of candidate AI models.

2. The method of claim 1, wherein the plurality of candidate AI models includes first and second candidate AI models having first and second quality potentials, respectively, the first quality potential being lower than the second quality potential, the determining further comprises selecting the first candidate AI model with the lower first quality potential instead of the second candidate AI model in connection with the load experienced by the one or more resources of the device exceeding a device load threshold.

3. The method of claim 1, wherein the plurality of candidate AI models includes first and second candidate AI models having first and second quality potentials, respectively, the first quality potential being higher than the second quality potential, the determining further comprises selecting the first candidate AI model with the higher first quality potential instead of the second candidate AI model in connection with the load experienced by the one or more resources of the device falling below a device load threshold.

4. The method of claim 1, wherein the quality potential for a candidate AI model is based, at least in part, on the degree of computational complexity of the candidate AI model.

5. The method of claim 1, wherein determining includes determining the AI model based on a solution-based constraint for the AI operation.

6. The method of claim 1, wherein determining further comprises selecting the AI model from a database of the plurality of candidate AI models and the quality potentials for each candidate AI model of the plurality of candidate AI models.

7. The method of claim 1, wherein the utilization information is indicative of the load experienced by the one or more resources of the device due to one or more of a level of processor usage, a level of memory usage, a level of a network load, and a level of battery charge.

8. The method of claim 1, further comprising executing the AI model on the device and generating a prediction based on the executing.

9. The method of claim 8, further comprising one or more of storing the prediction and acting on the prediction.

10. A device for dynamically determining an artificial intelligence (AI) model, the device comprising:
one or more processors;
memory storing program instructions accessible by the one or more processors, wherein, responsive to execution of the program instructions, the one or more processors:
receive a request for an AI operation;
analyze utilization information indicative of a load experienced by one or more resources of the device; and
determine an AI model from a plurality of candidate AI models based, at least in part, on the utilization information and a quality potential for each candidate AI model of the plurality of candidate AI models.

11. The device of claim 10, wherein the plurality of candidate AI models includes first and second candidate AI models having first and second quality potentials, respectively, the first quality potential being lower than the second quality potential, wherein the one or more processors, as part of the determine, selects the first candidate AI model with the lower first quality potential instead of the second candidate AI model in connection with the load experienced by the one or more resources of the device exceeding a device load threshold.

12. The device of claim 10, wherein the plurality of candidate AI models includes first and second candidate AI models having first and second quality potentials, respectively, the first quality potential being higher than the second quality potential, wherein the one or more processors, as part of the determine, selects the first candidate AI model with the higher first quality potential instead of the second candidate AI model in connection with the load experienced by the one or more resources of the device falling below a device load threshold.

13. The device of claim 10, wherein the quality potential for a candidate AI model is based, at least in part, on the degree of computational complexity of the candidate AI model.

14. The device of claim 10, wherein the one or more processors, as part of the determine, determines the AI model based on a solution-based constraint for the AI operation.

15. The device of claim 10, wherein the one or more processors, as part of the determine, selects the AI model from a database of the plurality of candidate AI models and the quality potentials for each candidate AI model of the plurality of candidate AI models.

16. The device of claim 10, wherein the utilization information is indicative of the load experienced by the one or more resources of the device due to one or more of a level of processor usage, a level of memory usage, a level of a network load, and a level of battery charge.

17. A computer program product comprising a non-transitory signal computer readable storage medium storing comprising computer executable code to:
receive a request for an AI operation;
analyze utilization information indicative of a load experienced by one or more resources of the device; and
determine an AI model from a plurality of candidate AI models based, at least in part, on the utilization information and a quality potential for each candidate AI model of the plurality of candidate AI models.

18. The computer program product of claim 17, wherein the plurality of candidate AI models includes first and second candidate AI models having first and second quality potentials, respectively, the first quality potential being lower than the second quality potential, wherein, as part of the determine, the computer executable code selects the first candidate AI model with the lower first quality potential instead of the second candidate AI model in connection with the load experienced by the one or more resources of the device exceeding a device load threshold.

19. The computer program product of claim 17, wherein the plurality of candidate AI models includes first and second candidate AI models having first and second quality potentials, respectively, the first quality potential being higher than the second quality potential, wherein, as part of the determine, the computer executable code selects the first candidate AI model with the higher first quality potential instead of the second candidate AI model in connection with the load experienced by the one or more resources of the device falling below a device load threshold.

20. The computer program product of claim 17, wherein the quality potential for a candidate AI model is based, at least in part, on the degree of computational complexity of the candidate AI model.
